(19) United States
(12) Patent Application Publication
(10) Pub. No.: US 2009/0101074 A1
(43) Pub. Date: Apr. 23, 2009

(54) Bird swing

(76) Inventor: Linda K. Bjelland, Harriman, TN (US)

Correspondence Address: JAMES RAY & ASSOCIATES, 2640 PITCAIRN ROAD, MONROEVILLE, PA, 15146, US

(21) Appl. No.: 12/231,925

(22) Filed: Sep. 8, 2008

Related U.S. Application Data
(60) Provisional application No. 60/980,482, filed on Oct. 17, 2007.

(51) Int. Cl. A01K 31/12

(52) U.S. Cl. 119/468

(57) ABSTRACT

An apparatus for providing at least one bird with a comfortable means for swinging. The apparatus comprises a pole member having a predetermined length and formed of a predetermined material. A first means is engageable with a top portion of the pole member and with such bird cage for connection of the pole member to a top portion of such bird cage; and a second means is disposed on a bottom portion of such pole member for connecting at least one peg member to such pole member, such at least one peg member providing a place for such bird's feet to grasp when such bird is swinging.

### CROSS REFERENCE TO RELATED APPLICATIONS

This application is closely related to and claims benefit from U.S. Provisional Application Ser. No. 60/980,482 filed Oct. 17, 2007.

### FIELD OF THE INVENTION

The present invention relates, in general, to an apparatus for birds, and, more particularly, the present invention relates to an bird swing that gives a bird a swing that enables up to three birds to swing at the same time and which has standing rods that are made of different sizes which are better for such bird's feet.

### BACKGROUND OF THE INVENTION

Many bird toys and swings are essentially the same thing only displayed in different colors. Most of the bird swings have stands that are all the same size and that can wear on a bird's feet if the size is not right. Some bird swings only fit certain types and sizes of cages. Multiple birds that share a cage would each have to have a swing to use so as to not start fights between the birds when both want to swing at the same time. Having multiple swings takes up valuable space in the cage and also could be a pain in the wallet to the owner.

Thus, it would be advantageous if there were a simple and effective bird swing that would permit multiple birds to swing at the same time.

### SUMMARY OF THE INVENTION

In a first aspect, the present invention provides an apparatus for providing at least one bird with a comfortable means for swinging. The apparatus comprises a pole member having a predetermined length and formed of a predetermined material; a first means is engageable with a top portion of said pole member and with such bird cage for connection of said pole member to a top portion of such bird cage; and a second means is disposed on a bottom portion of said pole member for connecting at least one peg member to said pole member, said at least one peg member providing a place for such bird's feet to grasp when such bird is swinging.

### OBJECTS OF THE INVENTION

It is, therefore, one of the primary objects of the present invention to provide a bird swing that can accommodate multiple birds simultaneously.

Another object of the present invention is to provide a bird swing that provides a comfortable roost for the birds feet.

Still another object of the present invention is to provide a bird swing that has a plurality of colored rings for the birds amusement.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a front perspective view of the apparatus according to an embodiment of the invention.

FIG. 2 is a is a perspective view of a bird cage with the apparatus show in FIG. 1 disposed in such bird cage.

FIG. 3 is a top perspective view of a plurality of ring members that are used as part of the apparatus.

FIG. 4 is a perspective view of the apparatus shown in FIG. 1 showing a different shaped platform member.

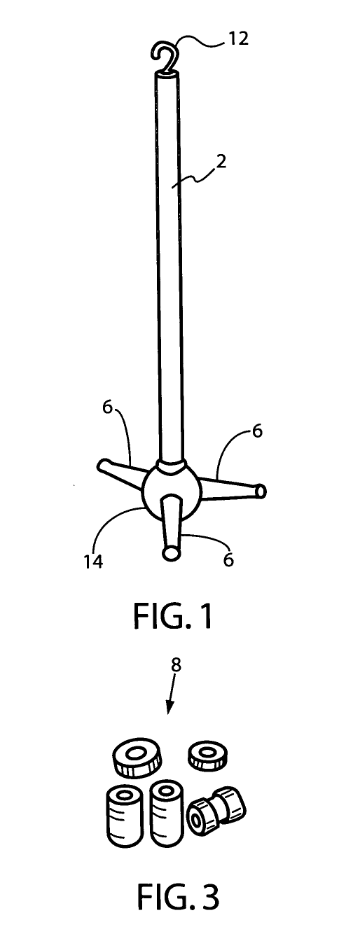

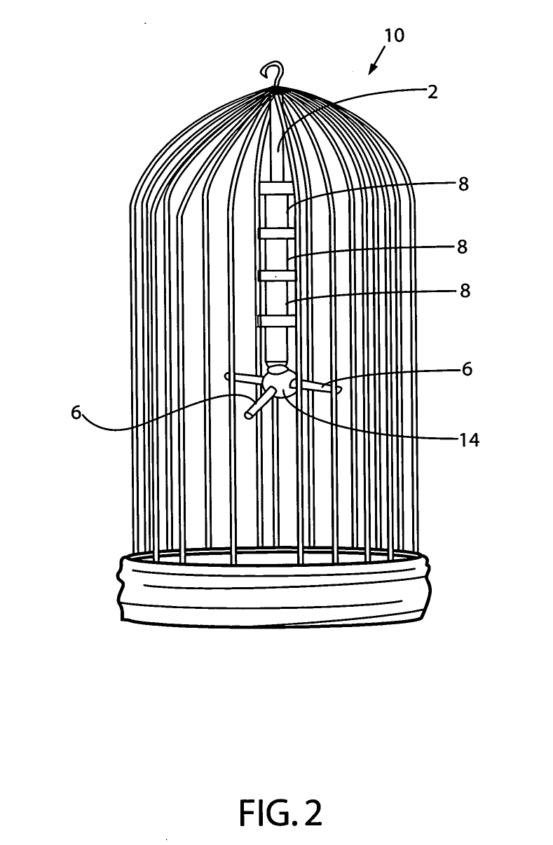

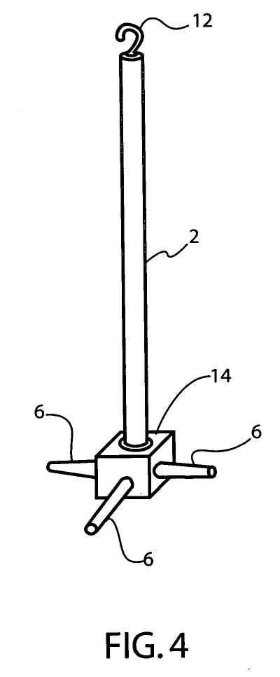

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing at least one bird with a comfortable means for swinging. The apparatus 10 comprises a pole member 2 having a predetermined length and formed of a predetermined material. A first means 20 is engageable with a top portion of such pole member 2 and with such bird cage 4 for connection of such pole member 2 to a top portion of such bird cage 4 and a second means 30 is disposed on a bottom portion of said pole member 2 for connecting at least one peg member 6 to such pole member 2, the at least one peg member 6 provides a place for such bird's feet to grasp when such bird is swinging.

Such predetermined material is one of plastic and wood. It is presently preferred that such material is wood.

The apparatus further includes a plurality of rings 8. It is also preferred that such plurality of rings 8 are formed of wood.

Such plurality of rings 8 are disposed on and encircle such pole member 2. Such first means 20 includes a hook 12.

Such apparatus 10 further includes a plurality of ring members 16 for providing entertainment for such birds. Such plurality of ring members 16 are disposed on and encircle said pole member 2.

Such plurality of ring members 16 are colored with various colors.

Such second means 30 includes a platform member 14 for engagement with a bottom portion of said pole member 2. Such platform member 14 is one of ball shaped, oval shaped, rectangular shaped, hexagonal shaped and octagonal shaped. It is presently preferred that such platform member 14 is ball shaped.

Such apparatus 10 further includes a predetermined plurality of peg members 6 connected to the ball shaped member 14 and extending outwardly therefrom for providing space for a plurality of birds to use the apparatus 10 simultaneously.

It is presently preferred that there are three peg members 6 connected to the ball shaped member 14 and that such peg members 6 are disposed in a uniform arrangement on the ball shaped member 14.

Thus the present invention provides an apparatus including a bird swing which provides birds with a comfortable stand that will not harm their feet. The bird swing is made of wood. It has a long pole that attaches to the top of the bird cage by means of a hook. The bottom of the pole has a large wooden ball that has three pegs extending outward from it for providing the ability for three birds to use the apparatus simultaneously. There are also a plurality of colored rings that are placed on the pole member that the birds can use for their own amusement.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for providing at least one bird with a comfortable means for swinging, said apparatus comprising:
(a) a pole member having a predetermined length and formed of a predetermined material;
(b) a first means is engageable with a top portion of said pole member and such bird cage for connection of said pole member to a top portion of such bird cage; and
(c) a second means is disposed on a bottom portion of said pole member for connecting at least one peg member to said pole member, said at least one peg member providing a place for such bird's feet to grasp when such bird is swinging.

2. The apparatus, according to claim 1, wherein said first means includes a hook.

3. The apparatus, according to claim 1, wherein said apparatus further includes a plurality of ring members for providing entertainment for such birds.

4. The apparatus, according to claim 3, wherein said plurality of rings are disposed on and encircle said pole member.

5. The apparatus, according to claim 4, wherein said plurality of ring members are colored with various colors.

6. The apparatus, according to claim 1, wherein said second means includes a platform member for engagement with a bottom portion of said pole member.

7. The apparatus, according to claim 6, wherein said platform member is one of ball shaped, oval shaped, rectangular shaped, hexagonal shaped and octagonal shaped.

8. The apparatus, according to claim 7, wherein said platform member is ball shaped.

9. The apparatus, according to claim 8, wherein said apparatus further includes a predetermined plurality of peg members connected to said ball shaped member and extending outwardly therefrom for providing space for a plurality of birds to use said apparatus simultaneously.

10. The apparatus, according to claim 9, wherein said apparatus includes three peg members connected to said ball shaped member.

11. The apparatus, according to claim 10, wherein said three peg members are disposed in a uniform arrangement on said ball shaped member.

12. The apparatus, according to claim 1, wherein said predetermined material is one of wood and plastic.

13. The apparatus, according to claim 12, wherein said predetermined material is wood.

14. The apparatus, according to claim 3, wherein said plurality of rings are formed of wood.
